(19) United States
(12) Patent Application Publication
(10) Pub. No.: US 2007/0082617 A1
(43) Pub. Date: Apr. 12, 2007

(54) Transceiver with isolation-filter compensation and method therefor

(75) Inventor: Ronald Duane McCallister, Scottsdale, AZ (US)

Correspondence Address: MESCHKOW & GRESHAM, P.L.C., 5727 NORTH SEVENTH STREET, SUITE 409, PHOENIX, AZ, 85014, US

(73) Assignee: CrestCom, Inc., Scottsdale, AZ (US)

(21) Appl. No.: 11/250,853

(22) Filed: Oct. 11, 2005

(51) Int. Cl. H04B 1/00

(52) U.S. Cl. 455/63.1

(57) ABSTRACT

A transceiver (10) includes an RF transmitter (12) and an RF receiver (14) coupled together through a duplexer (30). An RF transmit signal (20) passes through the duplexer (30) from the transmitter (12) toward an antenna (18), and an RF receive signal (44) passes through the duplexer (30) from the antenna (18) toward the receiver (14). The duplexer (30) may leak significant portions (56, 58) of the transmit signal (20) into the receive signal (44), and the duplexer (30) may significantly distort the transmit signal (20). Such distortion is compensated in the transmitter (12) through the use of a linear predistorter (68) that is adjusted in response to an RF feedback signal obtained from the antenna-side of the duplexer (30) . Transmit signal leakage is compensated in the receiver (14) by producing a processed-cancellation signal (106) that, when combined with the receive signal (44) cancels the transmit signal portions (56, 58) leaked into the receive signal (44). The processed-cancellation signal (106) is generated by applying a transformation function to a raw-cancellation signal (122) obtained from the antenna-side of the duplexer (30).

### RELATED INVENTIONS

This patent is related to “Transmitter Predistortion Circuit and Method Therefor” (Ser. No. 11/012,427, filed 14 Dec. 2004), “Equalized Signal Path with Predictive Subtraction Signal and Method Therefor” (Ser. No. 10/971,628, filed 22 Oct. 2004), “Predistortion Circuit and Method for Compensating A/D and Other Distortion in a Digital RF Communications Transmitter” (Ser. No. 10/840,735, filed 6 May 2004), “A Distortion-Managed Digital RF Communications Transmitter and Method Therefor” (Ser. No. 10/766,801, filed 27 Jan. 2004), “Predistortion Circuit-and Method for Compensating Linear Distortion in a Digital RF Communications Transmitter” (Ser. No. 10/766,768, filed 27 Jan. 2004), and to “Predistortion Circuit and Method for Compensating Nonlinear Distortion in a Digital RF Communications Transmitter” (Ser. No. 10/766,779, filed 27 Jan. 2004), each invented at least in part by the inventor of this patent and each of which is incorporated herein by reference.

### TECHNICAL FIELD OF THE INVENTION

The present invention relates generally to the field of radio-frequency (RF) communications. More specifically, the present invention relates to the-field of transceivers in which a transmitter and a receiver operate in different frequency bands, are physically located near one another, and in which the receiver benefits from being isolated from the transmitter, such as through the use of a duplexer.

### BACKGROUND OF THE INVENTION

When a transmitter and receiver are physically located near one another, the receiver needs to be isolated from the transmitter, particularly when the transmitter and receiver operate simultaneously. Isolation is needed so that the transmitter's transmitted signal does not interfere with the signal that the receiver is trying to receive. The isolation is accomplished to a great degree by configuring the transmitter and receiver to transmit and receive carrier signals respectively oscillating in non-overlapping frequency bands. But the-use of separate transmit and receive bands seldom provides sufficient isolation when the transmitter and receiver share an antenna or use antennas located near one another. When the transmitter and receiver are near one another, the transmit signal is at such a vastly greater amplitude than the receive signal that the transmit signal can overwhelm the receiver.

The transmit signal can overwhelm the receiver in two ways. First, the transmit signal includes energy in the transmit band. If this transmit-band energy is not vastly attenuated from the receive signal without significantly attenuating the receive-band energy, then the transmit-band energy can exceed the power limits of the input circuits in the receiver. When the power limits are exceeded, regardless of the frequency, the input circuits in the receiver cannot successfully process the receive signal.

A second way that the transmit signal may overwhelm the receiver results because the transmit signal often includes a small amount of energy in the receive band. This receive-band energy portion of the transmit signal often results from intermodulation due to nonlinear processing in a high-power amplifier (HPA) at the output section of the transmitter and may also result from linear amplification of out-of-band thermal noise at the HPA input. Desirably, any energy outside the transmit band, including energy falling in the receive band, is held to as low a level as possible. But inevitably, some small residual portion of receive-band energy is nevertheless present in a transmit signal. And, since the transmit signal is at such a vastly greater amplitude than the receive signal, this small residual portion of receive-band energy in the transmit signal might nevertheless exhibit a sufficient amplitude to interfere with the receive signal. Accordingly, adequate isolation often requires that the receive-band energy-be attenuated from the transmit signal without significantly attenuating the transmit-band energy.

It is a common practice to use a duplexer to provide the desired isolation between a transmitter and receiver. A duplexer essentially includes a “transmit” isolation filter for the transmit signal; where the transmit filter is configured to pass transmit-band energy but to attenuate receive-band energy. A duplexer also includes a “receive” isolation filter for the receive signal, where the receive filter is configured to pass receive-band energy but to attenuate transmit-band energy. A duplexer provides an added benefit of allowing the transmitter and receiver to share a common antenna. In particular, the output of the transmit filter and the input of the receive filter share a common port of the duplexer, and this common port couples to a shared antenna.

In order to be useful, the isolation filters, whether or not included in a duplexer, should exhibit low insertion loss. In other words, the transmit filter should minimally attenuate the transmit-band energy it passes, and the receive filter should minimally attenuate the receive-band energy it passes. All other design parameters remaining equal, increased insertion loss directly causes a reduced link margin, leading to a reduced radio range, reduced data communication rates, increased error rates, and /or the like.

Isolation filters should also exhibit flat responses throughout their passbands. In other words, the insertion loss should be constant over the entire passband of the isolation filter, whether for the transmit filter or the receive filter. Any rippling or other inconstancy in this response produces distortion, which again leads to reduced radio range, reduced data communication rates, increased error rates, and/or the like.

Furthermore, isolation filters should provide a narrow transition band. A narrower transition band for the transmit filter causes the transmit filter to more greatly attenuate receive-band energy without further attenuating transmit-band energy. Likewise, a narrower transition band for the receive filter causes the receive filter to more greatly attenuate transmit-band energy without further attenuating receive-band energy. An inadequately narrow transition band leads to inadequate isolation and interference with the receive signal.

Unfortunately, improvements in one of these three design criteria (i.e., insertion loss, flat response, and narrow transition band) are usually achieved-at the expense of at least one of the other two. Thus, a good duplexer having truly desirable design characteristics is difficult to obtain.

Furthermore, the problems of obtaining a good duplexer are exacerbated as transmitter power increases. As power increases, the ratio of the power of the transmit signal to the receive signal increases, making adequate isolation more difficult to achieve. And, while printed and photolithographic devices, such as surface acoustic wave (SAW) devices and film bulk acoustic resonator (FBAR) devices, may provide good low cost, low power duplexers, such devices are not currently available for transceiver applications with transmit power greater than about one watt.

For higher power applications, such as cellular base stations, which may transmit at up to several hundred watts of power, conventional duplexers that adequately balance insertion loss, flat response, and narrow transition band design criteria tend to be complex metallic structures that are complicated to manufacture, and often require individual manual tuning. As a consequence, such duplexers tend to be one of the more expensive components of a transceiver.

Accordingly, a need exists for a transceiver design that uses techniques other than relying solely on isolation filters to isolate a transmitter and a receiver. Such a transceiver design may operate in conjunction with isolation filters, but the isolation filters may then be less complicated, smaller, and less expensive than-conventional higher power isolation filters and/or duplexers. Alternatively, such a transceiver design may be used in a communication system with smaller transition bands between the transmit and receive bands.

### SUMMARY OF THE INVENTION

It is an advantage of at least one embodiment of the present invention that an improved transceiver with isolation-filter compensation and method therefor are provided.

Another advantage of at least one embodiment of the present invention is that a transceiver may use a relatively simple and inexpensive duplexer to isolate the receiver portion of the transceiver from the transmitter portion.

Another advantage of at least one embodiment of the present invention is that portions of a transmit signal that isolation filters leak into a receive signal are cancelled from the receive signal.

Another advantage of at least one embodiment of the present invention is that the transceiver and method are self-calibrating so that they adapt to different duplexer characteristics and to changes in duplexer characteristics over time and temperature.

Another advantage of at least one embodiment of the present invention is that the transceiver and method compensate for isolation-filter leakage over a wide receive-frequency band.

These and other advantages are realized in one form by a transceiver with isolation-filter compensation. The transceiver includes an RF transmitter configured to generate an RF transmit signal. A first isolation filter has an input adapted to receive the RF transmit signal and to pass the RF transmit signal to an output of the first isolation filter. An RF receiver is configured to process an RF receive signal. A second isolation filter has an input adapted to receive the RF receive signal and the RF transmit signal and has an output coupled to the RF receiver. The second isolation filter is configured to pass the RF receive signal from the input of the second isolation filter to the output of the second isolation filter and to leak a portion of the RF transmit signal at the output of the second isolation filter. A feedback control circuit also couples to the RF receiver. The feedback control circuit has a control input adapted to obtain the RF transmit signal from the first isolation filter. The feedback control circuit is configured to compensate the RF receiver for the leaked portion of the RF transmit signal at the output of the second isolation filter in response to the RF transmit signal obtained from the first isolation filter.

The above and other advantages are realized in another form by a method of operating an RF communications transceiver to compensate for leakage of an RF transmit signal into an RF receive signal. The method calls for generating the RF transmit signal. A portion of the RF transmit signal is extracted to form a raw-cancellation signal. A transformation function is applied to the raw-cancellation signal to generate a processed-cancellation signal. The processed-cancellation signal is combined with the RF receive signal to form a leakage-compensated receive signal. And, the transformation function is adjusted in response to the leakage-compensated receive signal.

### BRIEF DESCRIPTION OF THE DRAWINGS

A more complete understanding of the present invention may be derived by referring to the detailed description and claims when considered in connection with the Figures, wherein like reference numbers refer to similar-items throughout the Figures, and:

FIG. 1 shows a block diagram of an RF transceiver configured in accordance with the teaching of the present invention;

FIGS. 2-4 respectively show spectral transfer functions for ideal, complex, and simple duplexers, any one of which may be used in the RF transceiver of FIG. 1;

FIG. 5 shows a block diagram of an RF transmitter and a transmitter feedback control circuit from the RF transceiver of FIG. 1;

FIG. 6 shows a block diagram of an exemplary digital-subharmonic-sampling downconverter which may be used in the RF transceiver of FIG. 1;

FIG. 7 shows a block diagram of an RF receiver and a receiver feedback control circuit from the RF transceiver of FIG. 1; and

FIG. 8 shows a block diagram of an exemplary RF equalizer which may be used with the RF receiver of FIGS. 1 and 7.

### DETAILED DESCRIPTION OF THE PREFERRED EMBODIMENTS

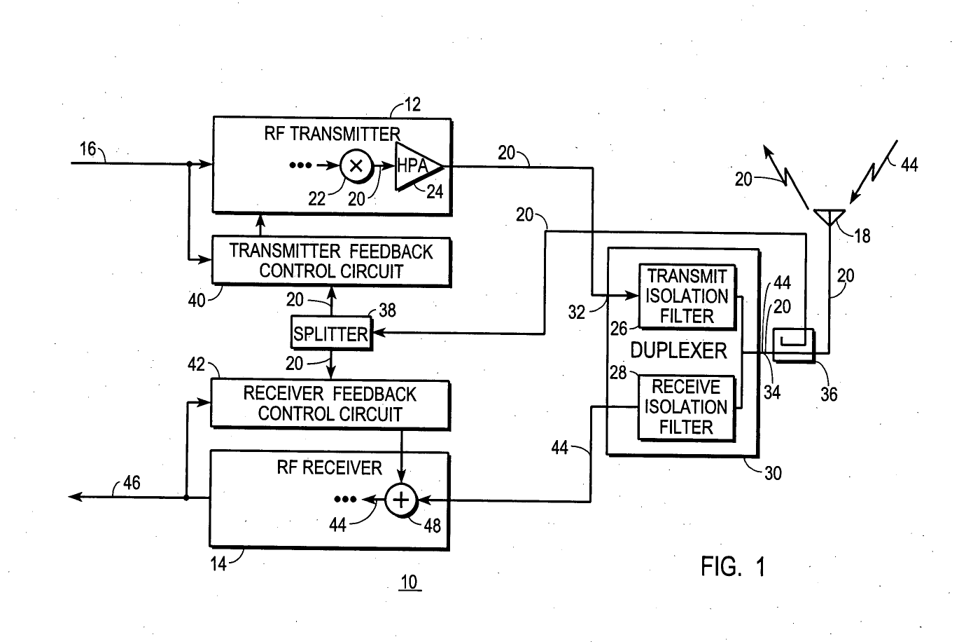

FIG. 1 shows a block diagram of a radio-frequency (RF) transceiver 10 configured in accordance with the teaching of the present invention. Transceiver 10 includes an RF transmitter 12 and an RF receiver 14. Transceiver 10 is the type of transceiver that may-be used at a cellular telephony cell-site base station, but transceiver 10 may be used in other applications as well.

A digitally modulated forward-data stream 16 is provided to an input of RF transmitter 12. In a preferred embodiment, forward-data stream 16 is a forward-communication signal that conveys information and is arranged as a complex data stream having quadrature-phase components. Those skilled in the art will appreciate that the complex notation is omitted herein from the figures in order to simplify the presentation of this subject matter. Forward-data stream 16 propagates in a forward direction with respect to transmitter 12. In other words, forward-data stream 16 propagates in a downstream direction toward an antenna 18 of transceiver 10 from which it is broadcast. Upstream refers to the opposite direction from which a signal, such as forward-data stream 16, propagates. For the purposes of this description, forward-data stream 16 and all digital data stream variants thereof produced by downstream processing in RF transmitter 12 are referred to as forward-data streams to distinguish them from return-data streams that are discussed below and which propagate in the opposite direction (i.e., away from antenna 18).

Forward-data stream 16 is a digitally modulated data stream. But the type of modulation used to produce forward data stream 16 is not a critical parameter of the present invention. Examples of modulations that may have been used in producing forward-data stream 16 include any type of quadrature-amplitude modulation (QAM), code-division-multiple-access (CDMA), orthogonal-frequency-division modulation (OFDM), multiple-input, multiple-output (MIMO) systems, and the like. Forward-data stream 16 may be viewed as a wideband data stream and may have resulted from combining a plurality of independently-modulated, complex-data streams together into a single complex forward-data stream 16. In addition, other processing may have been applied to forward-data stream 16 upstream of RF transmitter 12. Such other processing may have included pulse shaping filters that are configured to minimize inter-symbol interference (ISI) and peak or crest reduction circuits that reduce the peak-to-average power ratio of forward-data stream 16.

RF transmitter 12 generates an RF transmit signal 20 from the forward-communication signal provided by forward-data stream 16. Forward-data stream 16 is translated into RF transmit signal 20 at an upconversion section 22 of RF transmitter 12. For the purposes of this description, RF transmit signal 20 and all RF signal variants thereof produced by downstream processing in transceiver 10 are referred to as RF transmit signal 20 to distinguish them from an RF receive signal that is discussed below. Thus, RF transmit signal 20 is processed through a high-power amplifier (HPA) 24 and then routed to a transmit isolation filter 26.

While HPA 24 may amplify RF transmit signal 20 to any power level, transceiver 10 is primarily concerned with RF transmit signals at higher average power levels, preferably greater than one watt and more preferably greater than 100 watts. Such signals are often found in cellular base station applications and in other RF communications applications. While transceiver 10 will work acceptably well at lower power levels, the benefits of isolation-filter compensation provided by the present invention are believed to be best appreciated at higher power levels.

In a preferred embodiment, transmit isolation filter 26 and a receive isolation filter 28 are provided by a duplexer 30. An input of transmit isolation filter 26 serves as an transmitter port 32 for duplexer 30 and couples to-an output of RF transmitter 12. Within duplexer 30, an output of transmit isolation filter 26 couples to an input of receive isolation filter 28 and serves as an antenna port 34 of duplexer 30. Antenna port 34 of duplexer 30 couples to an input port of a directional coupler 36, and an output port of directional coupler 36 couples to antenna 18. Thus, RF transmit signal 20 passes through duplexer 30 at transmit isolation filter 26, through directional coupler 36, and to antenna 18 where it is broadcast from transceiver 10 with the intention of being received by some remotely located transceiver or receiver.

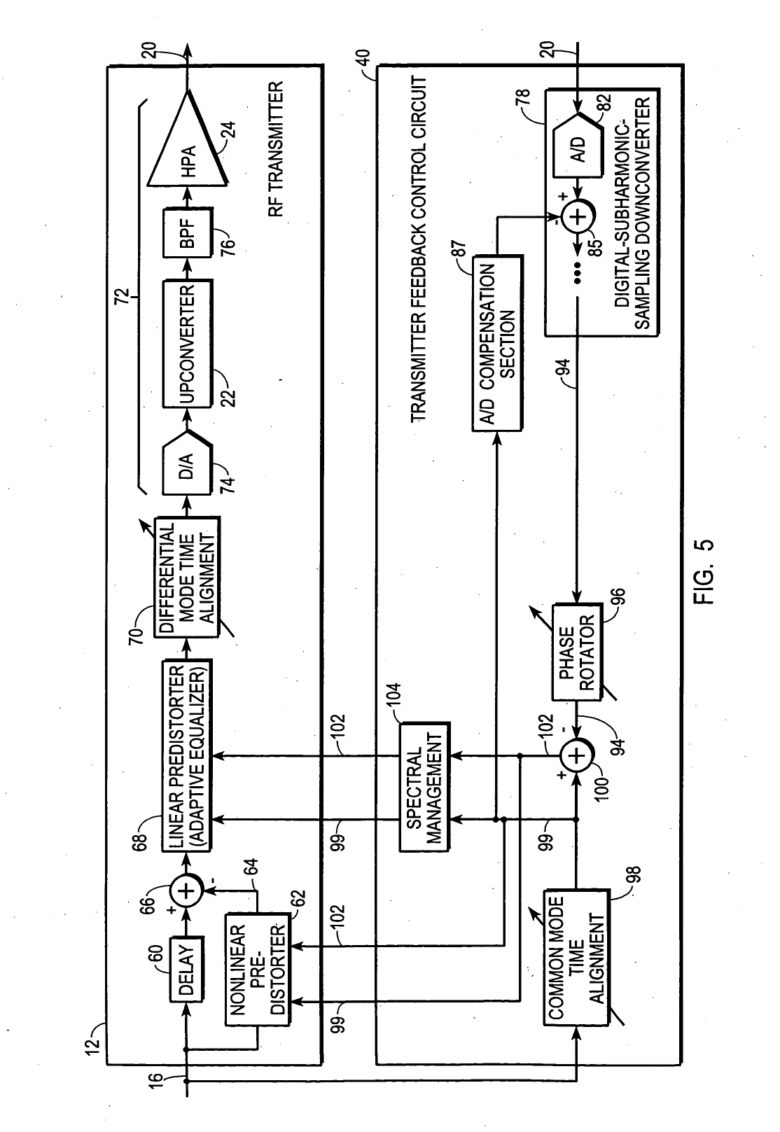

A portion, and preferably a very small portion, of RF transmit signal 20 is extracted at a coupled port of directional coupler 36 and routed to a splitter 38, where it is then routed to control inputs of a transmitter feedback control circuit 40 and a receiver feedback control circuit 42. Another input of transmitter feedback control circuit 40 is adapted to receive forward-data stream 16, and one or more outputs of transmitter feedback control circuit 40 are supplied to RF transmitter 12. Transmitter feedback control circuit 40 is configured to control predistortion applied to forward-data stream 16 in RF transmitter 12 to compensate for distortion imparted to RF transmit signal 20 in transmit isolation filter 26 and in analog transmitter components of RF transmitter 12. Transmitter feedback control circuit 40 and the predistortion applied in RF transmitter 12 are discussed in more detail below in connection with FIG. 5.

An RF receive signal 44 is received at antenna 18. In the preferred embodiment, RF receive signal 44 may be received at antenna 18 simultaneously with the broadcasting of RF transmit signal 20 from antenna 18. For the purposes-of this description, RF receive signal 44 and all RF signal variants thereof produced in transceiver 10 subsequent to reception at antenna 18 are referred to as RF receive signal 44 to distinguish them from RF transmit signal 20. RF receive signal 44 passes through directional coupler 36 in a reverse direction. But due to the directionality of directional coupler 36, no more than an insignificant portion of RF receive signal 44 is leaked at the coupled port of directional coupler 36. After passing through directional coupler 36 in a reverse direction, RF receive signal 44 is applied at antenna port 34 of duplexer 30 and at an input of receive isolation filter 28 Those skilled in the art will appreciate that receive isolation filter 28 thus receives a combination of RF transmit signal 20 and RF receive signal 44. An output of receive isolation filter 28 couples to an input of RF receiver 14 and serves as a receiver port for duplexer 30. To the maximum extent practical, receive isolation filter 28 blocks RF transmit signal 20 but passes RF receive signal 44. But as is discussed below in more detail, a portion of RF transmit signal 20 will also be leaked at the output of RF isolation filter 28.

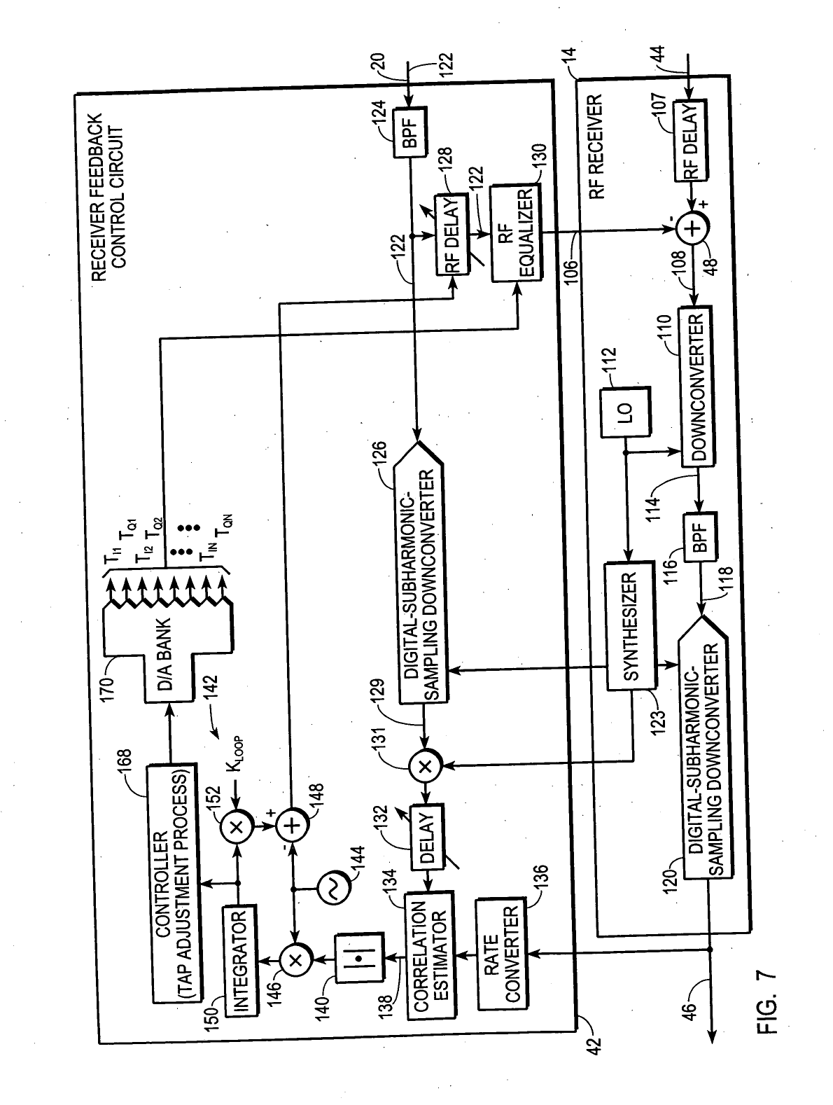

RF receiver 14 processes RF receive signal 44 by downconverting and digitizing. The output of RF receiver 14 is a modulated digital data stream 46, which-may be routed from RF receiver 14 to a digital demodulator and decoder (not shown). Digital data stream 46 is also routed to a control input of receiver feedback control circuit 42. And, an output of receiver feedback control circuit 42 couples to a combining circuit 48 within RF receiver 14. At combining circuit 48 the leaked portion of RF transmit signal 20 is cancelled from RF receive signal 44 in response to processing performed in receive feedback control circuit 42. In particular, receiver feedback control circuit 42 is configured to compensate RF receiver 14 for the leaked portion of RF transmit signal 20 in response to RF transmit signal 20 obtained through directional coupler 36 and splitter 38 and in response to digital data stream 46. Receiver feedback control circuit 42 and the compensation of RF receiver 14 are discussed below in more detail in connection with FIG. 7.

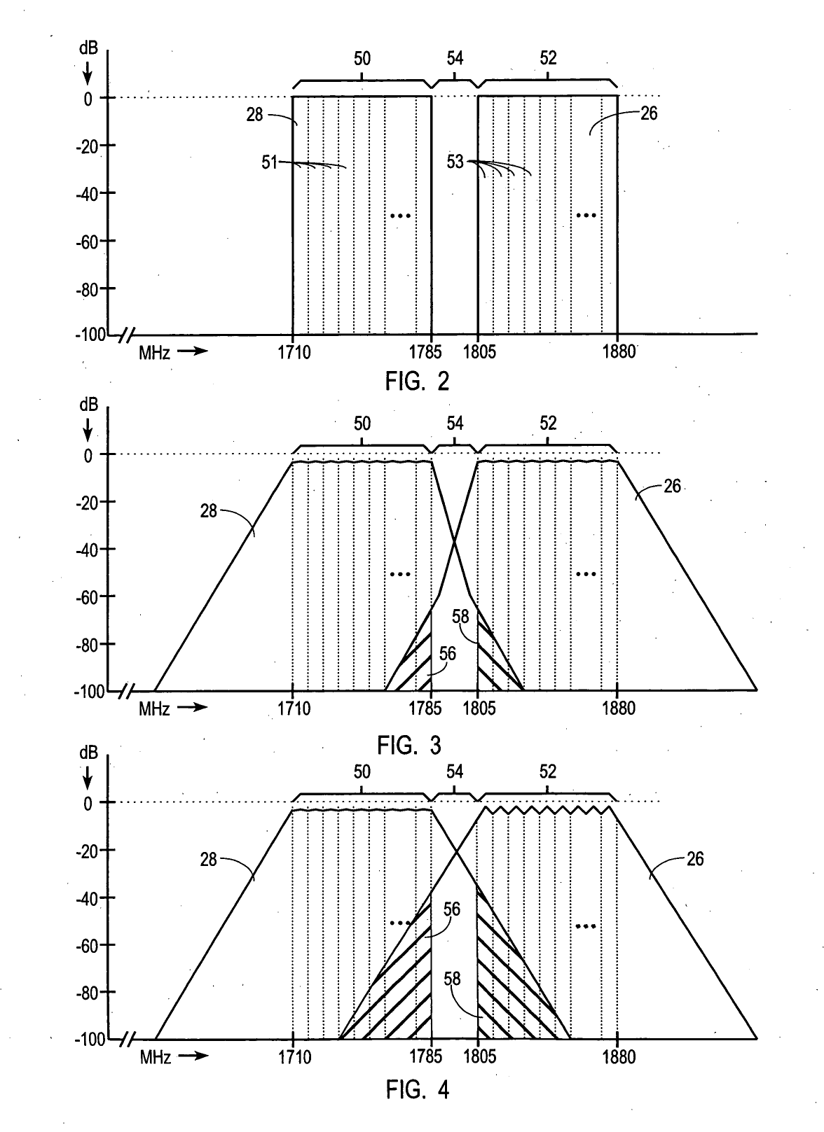

FIGS. 2-4 respectively show spectral transfer functions for ideal, complex, and simple duplexers, any one of which may serve as duplexer 30 (FIG. 1) within transceiver 10. The transfer functions are shown as spectral diagrams forming plots of attenuation versus frequency. Those skilled in the art will appreciate that the transfer functions provide a detailed characterization of transmit isolation filter 26 (FIG. 1) and of receive isolation filter 28 (FIG. 1). While FIGS. 2-4 indicate specific amounts of attenuation and specific frequency ranges, those skilled in the art will appreciate that these specifics are examples only and are provided to aid an understanding of the present invention, not to serve as any limitation whatsoever.

Of course, the ideal transfer function schematically depicted in FIG. 2 is impractical, if not impossible, to achieve using real-world components. But the ideal duplexer transfer function of FIG. 2 is presented here for comparison purposes with a complex duplexer transfer function (FIG. 3) and a simple duplexer transfer function (FIG. 4). Referring to FIGS. 1 and 2, a receive-frequency band 50 is shown positioned in the spectrum where the spectral content of RF receive signal 44 is primarily concentrated. Likewise, a transmit-frequency band 52 is positioned in the spectrum where the spectral content of RF transmit signal 20 is primarily concentrated. A number of vertical lines are in depicted within receive-frequency band 50 and within transmit-frequency band 52 to indicate that a number of discrete channels 51 and 53 may be simultaneously conveyed in each band. Transmit-frequency band 52 is separated from receive-frequency band 50 with no overlap between the two. In fact, a transition-frequency band 54 is positioned in the spectrum between receive-frequency band 50 and transmit-frequency band 52. A communication system within which transceiver 10 operates does not use transition-frequency band 54 for the communication of information. Rather, transition-frequency band 54 is provided to help in isolating RF transmit signal 20 from RF receive signal 44.

The ideal transfer functions of FIG. 2 depict ideal states for three characteristics of transmit isolation filter 26 and of receive isolation filter 28. First, the ideal transfer functions cause no insertion-loss. In other words, within each frequency band of interest the respective RF transmit and RF receive signals are not attenuated, as indicated by the tops of the transfer functions being at 0 dB in FIG. 2. Second, the ideal transfer functions provide a flat response. Thus, throughout each frequency band of interest, the attenuation or gain remains constant, shown at a-constant 0 dB in FIG. 2. And third, the ideal transfer functions provide for vertical transition bands, as indicated by the vertical walls at the lowest and highest frequencies in each frequency band.

The version of RF transmit signal 20 processed by duplexer 30 is an extremely high power signal relative to RF receive signal 44. And, the higher the average power level of the RF transmit signal 20 generated by HPA 24 the greater the difference between the two RF signals. The spectral content of RF transmit signal 20 is primarily concentrated in transmit-frequency band 52, but not entirely. Nonlinear distortion imposed on RF transmit signal 20 within RF transmitter 12, and typically within HPA 24, causes intermodulation, which expands the spectrum occupied by RF transmit signal 20 beyond transmit-frequency band 52. And, linear amplification of out-of-band thermal noise within HPA 24 also contributes. Desirably, any energy in RF transmit signal 20 outside of transmit-frequency band 52 is held to as low a level as possible. But some small amount of energy outside of transmit-frequency band 52 will inevitably be included in RF transmit signal 20, and some of this energy will fall in receive-frequency band 50. Since RF transmit signal 20 exhibits such an extremely high power level relative to RF receive-signal 44, even an extremely small fraction of receive-frequency band 50 energy within RF transmit signal 20 at the output of transmit isolation filter 26 can potentially interfere with RF receive signal 44.

But the ideal transmit isolation filter 26 depicted by FIG. 2 entirely blocks all energy outside of transmit-frequency band 52, including all energy falling within receive-frequency band 50. All out-of-band energy is blocked due to the vertical transition band characteristic of the ideal transmit isolation filter 26. Thus, no receive-frequency band 50 energy passes through transmit isolation filter 26 in RF transmit-signal 20, where it would most likely interfere with RF receive signal 44. On the other hand, all transmit-frequency band 52 energy included in RF transmit signal 20 passes through the ideal transmit isolation filter 26 due to the no insertion loss characteristic. And, the transmit-frequency band 52 energy is passed without distortion due to the flat response characteristic.

For the ideal transfer functions depicted by FIG. 2, an extremely high power, RF transmit signal 20 having energy perfectly confined to transmit-frequency band 52 is provided in combination with an extremely weak, RF receive signal 44 at the input to receive isolation filter 28. The spectral content of RF receive signal 44 is primarily concentrated in receive-frequency band 50. The ideal receive isolation filter 28 then entirely blocks all transmit band 52 energy from this combination signal, but passes all receive band 50 energy. Since the receive-frequency band 50 energy has been removed from RF transmit signal 20 by transmit isolation filter 26, only RF receive signal 44, and more precisely only so much of RF receive signal 44 as actually falls in receive-frequency band 50, passes to the output of receive isolation filter 28. The ideal transition band of receive isolation-filter 28 is responsible for blocking the transmit-frequency band 52 energy. And, the no-insertion-loss-and flat-response characteristics of receive isolation filter, 28 cause RF receive signal 44 to pass through receive isolation filter 28 without any attenuation or distortion. Accordingly, transmit isolation filter 26 and receive isolation filter 28 work together to isolate RF receiver 14 from RF transmitter 12.

FIG. 3 schematically depicts transfer functions for a practical but complex duplexer 30. Referring to FIGS. 1-3, compared-to the ideal transfer functions of FIG. 2, the complex transmit and receive isolation filters 26.and 28 associated with FIG. 3 apply small amounts of insertion loss to the RF signals they respectively process. FIG. 3, depicts these small insertion losses by illustrating the tops of the transfer functions being slightly below 0 dB. Desirably any insertion loss is held to a minimum. Moreover, compared to the ideal transfer functions of FIG. 2, the complex transmit and receive isolation filters 26 and 28 of FIG. 3 insert small amounts of distortion into the RF signals they respectively process. FIG. 3 depicts these small amounts of distortion by illustrating the tops of the transfer functions as being just slightly rippled. Desirably, any rippling is held to a minimum. And, compared to the ideal transfer functions of FIG. 2, the complex transmit and receive isolation filters 26 and 28 of FIG. 3 have narrow but not vertical transition bands. The narrow but not vertical transition bands permit some small amount of energy outside the respective receive-frequency band 50 and transmit-frequency band 52 to pass through receive isolation filter 28 and transmit isolation filter 26.

The narrow but not vertical transition bands more greatly attenuate out-of-band energy the further that energy is in frequency away from the filter's passband. As indicated by a Rₓ leakage component 56, receive-band energy in RF transmit signal 20 will be greatly attenuated at the output of transmit isolation filter 26 compared to at the input of transmit isolation filter 26. But receive-band energy will nevertheless be present in some small amount in RF transmit signal 20 at the input of receive isolation filter 28, particularly in that portion of receive-frequency band 50 that resides closest to transmit-frequency band 52. And, this receive-band energy of Rₓ leakage component 56 will not be further attenuated to any significant degree in receive isolation filter 28.

Likewise, as indicated by a Tₓ leakage component 58, transmit-band energy will be greatly attenuated at the output of receive isolation filter 28 compared to at the input of receive isolation filter 28. But transmit-band energy will nevertheless be present to some degree with RF receive signal 44 at the output of receive isolation filter 28, particularly in that portion of transmit-frequency band 52 that resides closest to receive-frequency band 50.

The complex duplexer 30 described by the transfer functions of FIG. 3 may be implemented in a manner understood by those skilled in the art by forming each of transmit isolation filter 26 and receive isolation filter 28 to be a band pass filter, a band pass filter cascaded with a band reject filter, or the like. At the higher power levels exhibited by HPA 24 (FIG. 1), this is conventionally implemented using a metallic, tuned-cavity duplexer having numerous resonant cavities. A complex, large, expensive, and heavy structure results. Moreover, such duplexers are often manually tuned to optimize their performance. Accordingly, due to the materials involved, the processing of those materials, and the manual labor involved in assembling and optimizing, such duplexers tend to be prohibitively expensive for many RF communications applications.

FIG. 4 schematically depicts transfer functions for a practical but simple duplexer 30. Those skilled in the art will appreciate that the FIG. 4 duplexer is simple only in comparison to the ideal and complex duplexers of FIGS. 2 and 3. This simple duplexer may be less expensive, may weigh less, and be smaller than the complex duplexer depicted in FIG. 3. Referring to FIGS. 1-4, compared to the complex-duplexer transfer functions of FIG. 3, the simple transmit and receive isolation filters 26 and 28 of FIG. 4 apply small amounts of insertion loss to the RF signals they respectively process. FIG. 4, depicts these small insertion losses by illustrating the tops of the transfer functions being slightly below 0 dB. Desirably any insertion loss is held to a minimum.

But compared to the transfer functions for the complex duplexer 30 of FIG. 3, the simple transmit isolation filter 26 of FIG. 4 may insert a greater amount of distortion-into RF transmit signal 20 than the complex transmit isolation filter of FIG. 3. A greater amount of distortion may be inserted due to the use of predistortion in RF transmitter 12 and of a transmitter feedback control circuit 40 to control that predistortion. Predistortion is applied upstream of transmit isolation filter 26 so as to compensate for the distortion that transmit isolation filter 26 inserts as well as other distortions that are applied in other portions of RF transmitter 12. Desirably, any distortion inserted into RF receive signal 44 by receive isolation filter 28 is approximately the same as that inserted in the more complex duplexer depicted by the transfer functions of FIG. 3. In other words, it is as low as is reasonably practical.

Moreover, the transition bands for transmit isolation filter 26 and for receive isolation filter 28 in the simple duplexer 30 of FIG. 4 may be relaxed or wider than those for the more complex duplexer 30 depicted by the transfer functions of FIG. 3. A consequence of the relaxed transition bands is that Rₓ leakage component 56 and Tₓ leakage component 58 are greater than for the more complex duplexer of FIG. 3. The greater Rₓ and Tₓ leakage components 56 and 58 may be tolerated in transceiver 10 because these leakage signals are compensated within RF receiver 14 through the use of cancellation techniques. The cancellation process is controlled through the use of a feedback loop controlled by receiver feedback control circuit 42.

FIG. 5 shows a block diagram of RF transmitter 12 and of transmitter feedback control circuit 40. RF transmitter 12 is adapted to receive forward-data stream 16 at baseband and to predistort forward-data stream 16 to compensate for distortions introduced downstream of the predistortion in transmit isolation filter 26 (FIG. 1) and in other analog transmitter components. The nature of the predistortion is controlled by transmitter feedback control circuit 40. Then, RF transmitter 12 converts the predistorted forward-data stream 16 into RF transmit signal 20 in preparation for being broadcast from antenna 18 (FIG. 1).

Forward-data stream 16 is received at a delay element 60 and at a nonlinear predistorter 62 within RF transmitter 12. Delay element 60 delays forward-data stream 16 by the amount of delay that forward-data stream 16 experiences in nonlinear predistorter 62.

Nonlinear predistorter 62 desirably generates a plurality of higher-order basis functions in response to forward-data stream 16. The basis functions are functionally related to forward-data stream 16 squared, cubed, taken to the fourth power, and so on. Desirably, the basis functions are as orthogonal to each other as is reasonably possible. Nonlinear predistorter 62 desirably-equalizes the basis functions through independent adaptive equalizers (not shown), then combines the equalized basis functions into a forward-data-stream-error signal 64. Forward-data stream 16 as delayed through delay element 60 and error signal 64 are combined together in a combination circuit 66 to insert “inverse” nonlinear distortion into forward-data stream 16. The amount and form of inverse nonlinear distortion applied at combination circuit 66 is configured to be the inverse of the nonlinear distortions RF transmit signal 20 will encounter downstream so that the downstream distortions will cancel the inverse distortion applied at combination circuit 66, resulting in less distortion in the broadcast version of RF transmit signal 20 than would result without the operation at combination circuit 66.

The adaptive equalizers-in nonlinear predistorter 62 desirably adapt equalizer coefficients in response to estimation-and-convergence algorithms. In other words, the adaptive equalizers desirably estimate equalizer coefficient values that will influence the amount of nonlinear distortion (e.g., distortion outside of transmit-frequency band 52, depicted in FIGS. 2-4) in RF transmit signal 20, then alter the coefficients over time to achieve decreasing amounts of nonlinear distortion until convergence is reached at a minimum amount of nonlinear distortion. The estimation-and-convergence algorithms are based upon feedback obtained from RF transmit signal 20 and controlled by transmitter feedback control circuit 40.

The nonlinear-predistorted version of forward-data stream 16 is routed from combination circuit 66 to a linear predistorter 68. Linear predistorter 68 uses an adaptive equalizer in a preferred embodiment to apply a linear predistortion transformation function to this version of the forward-data stream 16. As with nonlinear predistorter 62, linear predistorter 68 desirably adjusts equalizer coefficients in response to an estimation-and-convergence algorithm. The adaptive equalizer of linear predistorter 68 desirably estimates equalizer coefficient values that will influence the amount of linear distortion (e.g., distortion within transmit-frequency band 52, depicted in FIGS. 2-4) in RF transmit signal 20, then alters these coefficients over time to adjust the predistortion transformation function applied by the adaptive equalizer and to achieve decreasing amounts of linear distortion until convergence is reached at a minimum amount of linear distortion. The estimation-and-convergence algorithm trains linear predistorter 68 to reduce linear distortion in response to feedback obtained from RF transmit signal 20 and is controlled by transmitter feedback control circuit 40.

After predistortion in linear predistorter 68, forward-data stream 16 passes through a variable, differential-mode, time alignment section 70. Differential time alignment refers to relative delay inserted into one of the in-phase and quadrature-phase legs of the complex forward-data stream 16. Section 70 may be implemented using a fixed delay of less than one clock interval in one of the legs of forward-data stream 16 and an interpolator in the other.

After differential timing adjustment in section 70, forward-data stream 16 passes to analog transmitter components 72. Analog transmitter components 72 include separate digital-to-analog (D/A) converters 74 for each leg of the complex forward data stream 16. D/A's 74 convert forward-data stream 16 from digital to analog signals. Subsequent processing of the forward-data stream 16 will now be analog processing and-subject to the inaccuracies characteristic of analog processing. For example, the two different D/A's 74 may not exhibit precisely the same gain and may introduce slightly different amounts of delay. Such differences in gain and delay can lead to linear distortion in RF transmit signal 20. Moreover, so long as the different legs of the complex signal are processed separately in different analog components, the components are likely to apply slightly different frequency responses so that linear distortion is worsened by the introduction of frequency-dependent gain and phase imbalances. And, the frequency-dependent gain and phase imbalances worsen as the bandwidth of the communication signal widens.

The two complex legs of the analog signal pass from D/A's 74 to two low-pass filters (not shown), which can be the source of additional linear distortion by applying slightly different gains and phase shifts in addition to slightly different frequency-dependent characteristics. Then, the two complex legs pass to upconverter 22. Upconverter 22 mixes the two complex legs with a local-oscillator signal (not shown) in a manner known to those skilled in the art. Additional linear distortion in the form of gain and phase imbalance may be introduced, and local-oscillator leakage may produce an unwanted DC offset. In addition, upconverter 22 combines the two distinct legs of the complex signal and passes the combined signal, now referred to as RF transmit signal 20, to a band-pass filter (BPF) 76.

BPF 76 is configured to block unwanted sidebands in RF transmit signal 20, but will also introduce additional distortion. RF transmit signal 20 then passes from BPF 76 to HPA 24. HPA 24 is likely to be the source of a-variety of linear and nonlinear distortions introduced into RF transmit signal 20. In accordance with a Wiener-Hammerstein RF-amplifier model, HPA 24 acts like an input band-pass filter, followed by a memoryless nonlinearity, which is followed by an output band-pass filter. The memoryless nonlinearity generates an output signal that may be a higher-order complex polynomial function of its input. Each of input and output bandpass filters may introduce linear distortion, but probably little significant nonlinear distortion. On the other hand, the memoryless nonlinearity is a significant source of nonlinear distortion.

RF transmit signal 20 then passes from HPA 24 and from RF transmitter 12 to transmit isolation filter 26 (FIG. 1). But due to the analog processing of analog transmitter components 72, RF transmit signal 20 is already corrupted with various linear and nonlinear distortions. As discussed above, RF transmit signal 20 is then further corrupted, primarily by linear distortion introduced into RF transmit signal 20 in transmit isolation filter 26 as discussed above in connection with FIG. 3-4.

Transceiver 10 uses feedback obtained from RF transmit signal 20 after being distorted in transmit isolation filter 26 (FIG. 1) to control the linear and nonlinear predistortions applied to forward-data stream 16 so as to minimize the distortions. In particular, this RF transmit signal 20 is routed to transmitter feedback control circuit 40 through splitter 38 (FIG. 1) from directional coupler 36 (FIG. 1).

Within transmitter feedback control circuit 40, RF transmit signal 20 is routed to an input of a digital-subharmonic sampling downconverter 78. Desirably, RF transmit signal 20 is routed as directly as possible to downconverter 78 without being processed through analog components that will introduce a significant amount of linear or nonlinear distortion. Such distortions could be mistakenly interpreted by transmitter feedback control circuit 40 and by linear and nonlinear predistorters 68 and 62 as being introduced while propagating toward antenna 18 and compensated. Thus, reverse path distortions might possibly have the effect of causing predistorters 62 and 68 to insert distortion that will have no distortion-compensating effect on the actual RF transmit signal 20 broadcast from antenna 18 and will actually contribute to an increase in distortion.

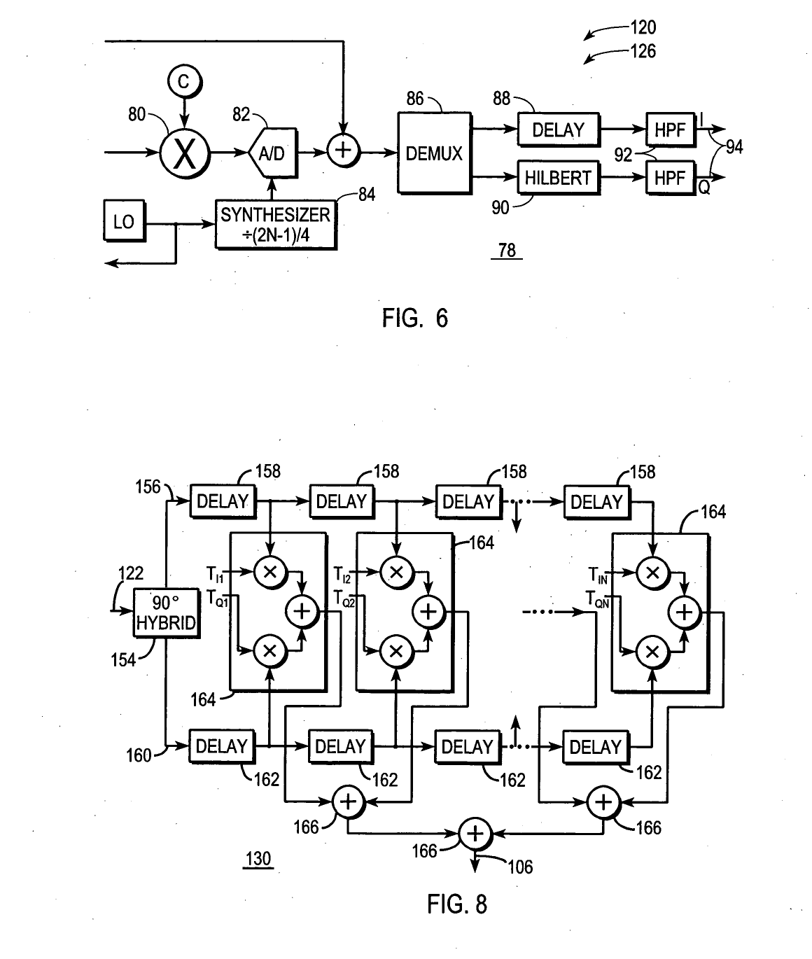

FIG. 6 shows a block diagram of an exemplary digital-subharmonic sampling downconverter 78 suitable for use transmitter feedback control circuit 40 and elsewhere within transceiver 10. Referring to FIGS. 5 and 6, downconverter 78 routes RF transmit signal 20 to a programmable-analog attenuator 80. Control inputs of attenuator 80 determine the amount of attenuation provided by attenuator 80 and are provided by a programmable controller (C). Attenuator 80 desirably attenuates the signal level of the reverse-propagating RF transmit signal 20 to compensate for the-gain inserted into the forward-propagating version of RF transmit signal 20 and attenuation provided by directional coupler 36.

An output of attenuator 80 couples to an input of an analog-to-digital converter (A/D) 82. Desirably, the same local-oscillator signal used by upconverter 22 passes to a synthesizer 84. Synthesizer 84 is desirably configured to multiply the local-oscillator frequency by four and divide the resulting product by an odd number, characterized as 2N±1, where N is a positive integer chosen to satisfy the Nyquist criteria for the bandwidth being downconverted, and is usually greater than or equal to ten. Since compensation for nonlinear distortion is contemplated, this bandwidth may be significantly wider than transmit-frequency band 52 (FIGS. 2-4) so as to capture energy from far outside of transmit-frequency band 52. As a result, A/D 82 performs a direct downconversion through subharmonic sampling.

The direct-subharmonic-sampling-downconversion process performed by A/D 82 requires that A/D 82 be capable of high-speed conversions. In addition,,the subharmonic sampling process tends to sum thermal noise from several harmonics of the baseband into the resulting baseband signal, thereby increasing noise over other types of downconversion. While these factors pose serious problems in many applications, they are no great burden here because only low resolution is required. Moreover, the low resolution demanded of A/D 82 likewise places no particular burden on the phase-noise in the clock signal generated by synthesizer 84 or aperture-jitter characteristic of A/D 82. The low resolution requirement is permitted due to the operation of the above-discussed estimation-and-convergence algorithms that result in an averaging effect which reduces the impact of noise, phase jitter, and/or aperture jitter.

Such estimation-and-convergence algorithms are used to translate increased arithmetic processing time into a reduced effective-error level for a return-data stream generated by downconverter 78. Thus, the low resolution is effectively increased by processing a multiplicity of samples before decisions are made based on feedback signals, and no single sample or even small or medium size groups of samples have a significant influence by themselves on decisions made based on the feedback signals. High-quantization error and high-thermal-noise error pose no particular problem.

A/D 82 provides a digital-data stream, and subsequent processing will not be subject to analog inaccuracies. That digital-data stream characterizes the complex feedback signal as a combination signal in which the I and Q legs are combined. together. Subsequent processing is performed to appropriately position the subharmonic of interest at baseband and to separate the I and Q legs of the complex signal. Although processing is subsequently performed independently on the I and Q legs of the complex signal, such processing is performed digitally, so no linear distortion is introduced due to quadrature imbalances and/or diverse frequency-dependent gain and phase characteristics.

In particular, the digital-data stream output from A/D 82 is routed through an optional combining circuit 85 to a demultiplexer (DEMUX) 86. Optional combining circuit 85 combines this digital-data stream with a linearizing signal obtained from an A/D compensation section 87 to improve the linearity of A/D 82, if necessary. While A/D 82 need not provide high resolution or low jitter characteristics, a high degree of linearity is desirable because any reduction in linearity might possibly be misinterpreted as being introduced into the forwardly-propagating RF transmit signal 20 and mistakenly compensated with in predistorter 68. To the extent that A/D 82 fails to exhibit sufficient linearity, the linearizing signal may be used to improve compensate for nonlinearity in A/D 82.

Demultiplexer 96 separates the data stream from A/D 82 into even-and-odd-sample-data streams. One of these even-and-odd-sample-data streams is merely delayed in a delay element 88, while the other is transformed in a Hilbert-transformation section 90. Outputs from element 88 and section 90 are filtered in high-pass filters (HPF's) 92 to remove DC, where they then collectively serve as a complex-return-data stream 94. Of course, the rates of the data streams slow as they propagate through downconverter 78, and clock signals are appropriately divided down (not shown) to support the decreasing data rates. In one embodiment high-pass filters 92 may be matched by other high-pass filters (not shown) having substantially the same spectral characteristics but positioned where forward-data stream 16 is input to transmitter feedback control circuit 40 so that HPF's 92 insert no unwanted spectral bias.

FIG. 6 depicts one form of a complex-digital-subharmonic-sampling downconverter suitable for use as downconverter 78. But those skilled in the art can devise other forms of direct-digital-subsampling downconversion that will also be acceptable. While direct downconversion is desirable because it does not introduce different analog inaccuracies into the I and Q legs which can lead to linear distortion or other analog inaccuracies that can lead to nonlinear distortion, in higher-frequency applications (e.g., greater than 2.5 GHz) downconversion may be performed in two stages, with the first stage being an analog downconversion. In this situation distortion introduced by the first analog downconversion stage will be less significant because it will be applied over a significantly narrower bandwidth as a percentage of the carrier frequency.

Referring back to FIG. 5, complex-return-data stream 94 passes from downconverter 78 to a variable phase rotator 96. Variable phase rotator 96 is adjusted to alter the phase of complex-return-data stream 94 primarily to compensate for the phase rotation introduced by BPF 76 in RF transmitter 12. Forward-data stream 16 is also routed to a control input of transmitter feedback control circuit 40. In particular, forward-data stream 16 passes to a variable common mode time alignment section 98. Common mode time alignment refers to delay that is inserted equally into both of the in-phase and quadrature-phase legs- of the complex forward-data stream 16. Section 98 delays forward-data stream 16 at the output of section 98 to form a delayed-forward-data stream 99 that is in temporal alignment with return data stream 94 at the output of phase rotator 96. At these locations delayed-forward-data stream 99 is combined in a combiner lob with return data stream 94 to form an error stream 102. Desirably, differential mode time alignment section 70, phase rotator 96, and common mode time alignment section 98 are all adjusted so that the correlation between delayed forward-data stream 94 and return-data stream 94 output from phase rotator 96 is maximized.

It is delayed-forward-data stream 99 that drives optional A/D compensation section 87. And, delayed-forward-data stream 99 and-error stream 102 together control nonlinear predistorter 62 and linear predistorter 68 within RF transmitter 12. In particular, the adaptive equalizers included in nonlinear predistorter 62 adapt their equalizer coefficients in response to a lengthy integration of the correlation between delayed-forward-data stream 99 and error stream 102. Equalizer coefficients are adjusted to minimize the integrated correlation between these streams.

Likewise, the adaptive equalizer of linear predistorter 68 adapts its equalizer coefficients in response to a lengthy integration of the correlation between delayed-forward-data stream 99 and error stream 102. Equalizer coefficients are adjusted to minimize the integrated correlation between these streams. But in connection with linear predistorter 68, delayed-forward-data stream 99 and error stream 102 may optionally be switched through a spectral management section 104. When transmit-frequency band 52 (FIGS. 2-4) is channelized and the different channels may be transmitted at significantly different power levels, spectral management section 104 may be included so that the adjustment of coefficients within linear predistorter 68 is responsive to weaker channels so that an error vector magnitude (EVM) characteristic may be maintained individually on each of the channels.

FIG. 7 shows a block diagram of RF receiver 14 and of receiver feedback control circuit 42. RF receiver 14 is adapted to receive RF receive signal 44 from the output of receive isolation filter 28 (FIG. 1) and the receiver port of duplexer 30 (FIG. 1). As discussed above, RF receive signal 44 may include Rₓ and Tₓ leakage components 56 and 58, respectively (see FIGS. 3-4). Those skilled in the art will appreciate that various buffer amplifiers and other signal-conditioning circuits conventionally included in RF communication receivers may also be included in RF receiver 14 but may be omitted from the depiction of FIG. 7 to clarify the subject matter relevant to the preferred embodiments discussed herein.

Receiver feedback control circuit 42 generates a processed cancellation signal 106 which passes to an input of combining circuit 48 within RF receiver 14. RF receive signal 44 passes through a fixed RF delay element 107 so that processed cancellation signal 106 may be adjustably delayed within receiver feedback control circuit 42 so that it is temporally aligned with RF receive signal 44. As will be discussed in more detail below, processed cancellation signal 106 is formed from RF transmit signal 20, and temporal alignment is desirably maintained between Rₓ and Tₓ leakage components 56 and 58 in RF receive signal 44 and RF transmit signal 20 as processed into processed cancellation signal 106.

An output of combining circuit 48 produces a leakage-compensated receive signal 108 that passes to an input of a downconverter 110. A local oscillator 112 provides a local oscillator signal to another input of downconverter 110. Downconverter 110 may be implemented-in one or two stages to convert leakage-compensated receive signal 108 into a downconverted-leakage-compensated receive signal 114 which is preferably positioned close to baseband. Desirably, when receive-frequency band 52 is divided into channels 51 (FIGS. 2-4), downconverter 110 positions the one of-channels 51 which is the subject of reception as close to baseband as practical. Then, downconverted-leakage-compensated receive signal 114 passes to a bandpass filter (BPF) 116. BPF 116 is configured to pass only the single channel 51 that is positioned at near baseband, and to substantially attenuate sidebands and other channels. Thus, BPF 116 is configured to exhibit a passband more narrow than the passband exhibited by receive isolation filter 28 in duplexer 30 (FIG. 1). BPF 116 reduces the noise that a demodulator located downstream of RF receiver 14 must tolerate.

BPF 116 produces a reduced-bandwidth-downconverted-leakage-compensated-receive signal 118 that passes to an input of a digital-subharmonic-sampling downconverter 120. Downconverter 120 may be implemented in a manner similar to that described above in connection with FIG. 6. An analog-to-digital converter (A/D) within downconverter 120 receives a clock signal from a synthesizer 123, which operates in substantially the same manner as synthesizer 84 from FIG. 6. Desirably, the A/D within downconverter 120 is a high precision A/D, but this A/D need to be operated at an extremely fast conversion rate since it operates at near baseband and needs to digitize only one of channels 51. Downconverter 120 produces modulated digital data stream 46, and modulated digital data stream 46 is a complex baseband data stream that digitally represents reduced-bandwidth-downconverted-leakage-compensated-receive signal 118.

RF transmit signal 20 from the output of transmit isolation filter 26 (FIG. 1) is the source of the Rₓ and Tₓ leakage components 56 and 58 in the RF receive signal 44 input at RF receiver 14. A portion of this RF transmit signal 20 is extracted through directional coupler 36 (FIG. 1) and routed through splitter 38 (FIG. 1) to a control input of receiver feedback control circuit 42. This version of RF transmit signal 20 is referred to as a raw-cancellation signal 122 below.

Raw cancellation signal 122 is first filtered within receiver feedback control circuit 42 through a bandpass filter (BPF) 124. Desirably, BPF 124 exhibits a transfer function approximately equal to the transfer function of receive isolation filter 28 within duplexer 30. In other words, BPF 124 passes receive-frequency band 50 and attenuates transmit-frequency band 52. Receive signal 44, including Rₓ and Tₓ leakage components 56 and 58, pass through receive isolation filter 28 prior to arriving at combiner 48. With BPF 124 having an approximately equal transfer function, raw-cancellation signal 122 after filtering in BPF 124 should include components spectrally close to Rₓ and Tₓ leakage components 56 and 58 in RF receive signal 44. But BPF 124 need not exhibit an exactly equal transfer function to that of receive isolation filter 28. Desirably BPF 124 is formed from much less expensive filter components than receive isolation filter 28 because BPF 124 need not handle the power that is required of receive isolation filter 28. Any inequality in transfer function will be compensated for in an RF equalizer which is adaptively adjusted in a feedback loop to maximize the achievable cancellation of Rₓ and Tₓ leakage components 56 and 58.

After processing in BPF 124, raw-cancellation signal 122 passes to an input of a digital subharmonic sampling downconverter 126 and to an input of an adjustable RF delay circuit 128. A delayed version of raw-cancellation 122 output from RF delay circuit 128 passes to an RF equalizer 130, where its spectral coloring is altered so that processed-cancellation signal 106, which is generated by RF equalizer 130, more closely resembles Rₓ and Tₓ leakage components 56 and 58 in RF receive signal 44.

Downconverter 126 may also be implemented in a manner similar to that described above in connection with FIG. 6. An analog-to-digital converter (A/D) within downconverter 126 receives a clock signal from synthesizer 123. Since downconverter 126 performs a digital downconversion from RF, the clock supplied thereto from synthesizer 123 exhibits a much greater frequency than the clock supplied to downconverter 120. The output of downconverter 126 is a complex, downconverted-digital-raw-cancellation-signal stream 129, and this stream 129 exhibits a greater data rate than digital data stream 46. But digital stream 129 need not exhibit high precision.

Digital stream 129 passes from downconverter 126 to an input of a complex multiplication circuit 131, and another input of multiplication circuit 131 receives a clock signal from synthesizer 123. Multiplication circuit 131 performs another downconversion process so that energy from the channel 51 that corresponds to digital data stream 46 resides at baseband. This baseband digital stream passes through a variable delay circuit 132 to a first input of a correlation estimator 134. And, digital data stream 46, which serves as the output from RF receiver 14, couples to a control input of receiver feedback control circuit 42, where it passes through a rate converter 136 and is provided to a second input of correlation estimator 134. Rate converter 136 steps up the data rate of digital data stream 46 to match that of raw-cancellation signal stream 129. Rate converter 136 may be implemented using an interpolator. Correlation estimator 134 may be implemented as a complex multiplier and may include some averaging or filtering to somewhat smooth a correlation stream 138 it generates. This correlation stream 138 passes through a magnitude circuit 140, which may perform an absolute value, squaring, or similar function, to remove polarity information from correlation stream 138. Correlation stream 138 then passes from magnitude circuit 140 to a delay controller 142.

In one embodiment, delay controller 142 is implemented as a feedback loop that generates a control voltage which establishes the amount of delay inserted into raw-cancellation signal 122 by RF delay circuit 128. Digital data stream 46 represents an error signal that describes the difference between RF receive signal 44 and processed-cancellation signal 106, where processed-cancellation signal 106 is spectrally close to, and produced in response to, raw-cancellation signal 122. In general, correlation between this difference signal and raw-cancellation signal 122 should be at a minimum magnitude when processed-cancellation signal 106 is temporally aligned with RF receive signal 44 at combining circuit 48. So, delay controller 142 is configured to continually, but slowly and minimally, adjust the control voltage which establishes the temporal alignment to maintain as low a correlation as possible.

In particular, a sine wave generator 144 generates a digitized version of a very slowly oscillating and very low amplitude sinusoidal signal which is applied to an input of a multiplication circuit 146 and an input of a combining circuit 148. The magnitude of correlation stream 138 is applied at another input of multiplication circuit 146. Accordingly, multiplication circuit 146 determines whether the correlation magnitude itself is positively or negatively correlated with the positive and negative excursions of the sinusoidal signal. This determination is integrated over a lengthy period in an integrator 150, and the integration result is multiplied by a loop constant (K_{LOOP}) in a multiplier 152, then the resulting product is fed back to close the feedback loop for delay controller 142 at combiner 148. The output from combiner 148 passes to a control input of RF delay circuit 128.

The insertion of the sinusoidal signal has no permanent effect on temporal alignment because it exhibits a zero mean and the feedback loop of delay controller 142 is integrated over a lengthy period. But the sinusoidal signal imposes perturbations that continually but incrementally adjust the value held in integrator 150 in the direction that minimizes the magnitude of the correlation determined in correlation estimator 134.

While FIG. 7 presents one preferred form of delay controller 142, those skilled in the art will appreciate that alternate delay controllers 142 may also be devised. One such alternate delay controller 142 may implement using an early-late gate structure. These and other alternatives are intended to be included within the scope of this invention.

FIG. 8 shows a block diagram of an exemplary RF equalizer 130 which may be used in receiver feedback control circuit 42. RF equalizer 130 equalizes raw-cancellation signal 122 by applying a transformation function to raw-cancellation signal 122. Referring to FIG. 8, the delayed version of raw-cancellation signal 122 output from RF delay circuit 128 passes to an input of a quadrature hybrid 154. An in-phase signal 156 produced at hybrid 154 passes through an in-phase tapped delay line 158, and a quadrature-phase signal 160 produced at hybrid 154 passes through a quadrature-phase tapped delay line 162. Respective taps in delay lines 158 and 162 couple to in-phase and quadrature-phase signal inputs of a plurality of vector multipliers 164. Preferably, an odd number of taps are included in each tapped delay line 158 and 162, and the same odd number of vector multipliers 164 is included in RF equalizer 130, but this is not a requirement. Outputs of vector multipliers 164 are collected together through one or more combination circuits 166, and a collected output from combination circuits 166 provides processed-cancellation signal 106. Each of vector multipliers 164 multiplies its respective delayed version of raw-cancellation signal 122 by coefficients (T_{I1}, T_{Q1}, T_{I2}, T_{Q2}, . . . , T_{IN}, T_{QN}) . Desirably, these coefficients are selected and dynamically adjusted to maximize the amount of cancellation achieved at combining circuit 48 (FIG. 7). It is these tap coefficients that define the transformation function applied to raw-cancellation signal 122 by RF equalizer 130.

Referring back to FIG. 7, a programmable controller 168 is adapted to obtain the integration results from integrator 150. Controller 168 then performs a tap adjustment process to determine the coefficients (T_{I1}, T_{Q1}, T_{I2}, T_{Q2}, . . . , T_{IN}, T_{QN}) used by RF equalizer 130. These coefficient values are written to registers associated with a bank 170 of digital-to-analog (D/A) converters, from which analog versions of these coefficient values are routed to respective vector multiplier inputs within RF equalizer 130.

A variety of different tap adjustment processes may be performed by controller 168. One such process may be described as follows. From a steady state condition,, controller 168 adjusts each tap's coefficient a small step in each of positive and negative directions. After each adjustment, a sufficient interval of time is provided before making the next adjustment so that the integrated results achieved in integrator 150 have fully responded to the previous adjustment. And, before making a subsequent adjustment, the previously adjusted tap coefficient is returned to its original state. The well integrated result from each adjustment is saved for later evaluation. When each tap's coefficients have been adjusted in each of positive and negative directions, controller 168 then examines the results for all coefficients and selects the single positive or negative tap coefficient adjustment that provided the lowest magnitude correlation value in integrator 150. That tap coefficient is set to reflect its prior adjustment that achieved the most significant reduction in correlation. Then, the process repeats indefinitely with small positive and negative adjustments in all tap coefficients.

In order to arrive at an initial steady state condition from which feedback loops may then be expected to produce desirable results, it may be desirable to perform an initialization process. One such process may be described as follows. Variable digital delay element 132 is first adjusted so that the delay in raw-cancellation signal 122 as it propagates from the output of transmit isolation filter 126 (FIG. 1) through downconverter 126 until it reaches its input of correlation estimator 134 matches the propagation delay of Rₓ and Tₓ leakage components 56 and 58 as they propagate from the output of transmit isolation filter 126 through downconverter 110 until they reach their input of correlation estimator 134. This temporal alignment process may be accomplished by setting all coefficients in RF equalizer 130 to zero, then adjusting variable delay element 132 until a maximum correlation is observed at integrator 150. Then, center tap coefficients for RF equalizer 130 may be set to a significant value, holding all other tap coefficients at a zero value for a period of time so that delay controller. 142 may arrive at a value that optimally adjusts the delay through RF delay circuit 128, as discussed above. Then a previously used or default set of coefficients, if available, may be preset into RF equalizer 130. At this point, initialization is complete and the above-discussed tap adjustment process may be indefinitely repeated to adjust tap coefficients to optimize the cancellation achieved at combining circuit 48. But the initialization process may also be repeated from time to time if needed.

In summary, the present invention provides an improved transceiver with isolation-filter compensation and method therefor. A transceiver configured in accordance with the teaching of the present invention may use a relatively simple and inexpensive duplexer to isolate the receiver portion of the transceiver from the transmitter portion. In accordance with at least one embodiment for the present invention, portions of a transmit signal that isolation filters leak into a receive signal are cancelled from the receive signal. In accordance with at least one embodiment for the present invention, the transceiver and method are self-calibrating so that they adapt to different duplexer characteristics and to changes in duplexer characteristics over time and temperature. Little manual labor is required for a cost savings, and optimum tuning is maintained even if different types of duplexers are used or if duplexer characteristics change over time and/or temperature. In accordance with at least one embodiment for the present invention, the transceiver and corresponding method compensate for isolation filter leakage over a wide receive-frequency band.

Although the preferred embodiments of the invention have been illustrated and described in detail, it will be readily apparent to those skilled in the art that various modifications may be made therein without departing from the spirit of the invention or from the scope of the appended claims. For example, those skilled in the art will appreciate that isolation filters need not be included in a duplexer as described herein but may be associated with separate nearby antennas. Those skilled in the art will also appreciate that a duplexer may be provided that includes a directional coupler located within the duplexer. Such a directional coupler may be located between the output of the transmit isolation filter and antenna port of the duplexer. And, those skilled in the art will appreciate that devices other than the directional coupler described herein, such as a circulator, may be used in lieu of or in addition to the directional coupler to achieve isolation between RF transmit and RF receive signals propagating in opposite directions over a common transmission line. These and other modifications and adaptations which are obvious to those skilled in the art are to be included within the scope of the present invention.

What is claimed is:

1. A transceiver with isolation-filter compensation, said transceiver comprising:
an RF transmitter configured to generate an RF transmit signal;
a first isolation filter having an input adapted to receive said RF transmit signal and to pass said RF transmit signal to an output of said first isolation filter;
an RF receiver configured to process an RF receive signal;
a second isolation filter having an input adapted to receive said RF receive signal and said RF transmit signal and having an output coupled to said RF receiver, said second isolation filter being configured to pass said RF receive signal from said input of said second isolation filter to said output of said second isolation filter and to leak a portion of said RF transmit signal at said output of said second isolation filter; and
a feedback control circuit coupled to said RF receiver, said feedback control circuit having a control input adapted to obtain said RF transmit signal from said first isolation filter, and said feedback control circuit being configured to compensate said RF receiver for said leaked portion of said RF transmit signal at said output of said second isolation filter in response to said RF transmit signal obtained from said first isolation filter.

2. A transceiver as claimed in claim 1 wherein:
said first isolation filter is configured to distort said RF transmit signal while passing said RF transmit signal to said output of said first isolation filter;
said feedback control circuit is a first feedback control circuit;
said transceiver additionally comprises a second feedback control circuit; and
said second feedback control circuit is coupled to said RF transmitter and to said output of said first isolation filter, said second feedback control circuit having a control input adapted to obtain said RF transmit signal from said output of said first isolation filter, and said second feedback control circuit being configured to control predistortion applied in said RF transmitter to compensate for distortion imparted to said RF transmit signal by said first isolation filter in response to said RF transmit signal obtained from said output of said first isolation filter.

3. A transceiver as claimed in claim 1 wherein:
said control input of said feedback control circuit is a first control input, and said RF transmit signal obtained at said first control input is a raw-cancellation signal;
said feedback control circuit has a second control input coupled to said RF receiver and adapted obtain a leakage-compensated receive signal, and an output coupled to said RF receiver and configured to provide a processed-cancellation signal which compensates for said leaked portion-of said RF transmit signal at said output of said second isolation filter.

4. A transceiver as claimed in claim 3 wherein said RF receiver comprises a combiner configured to combine said RF receive signal with said processed-cancellation signal to generate said leakage-compensated receive signal.

5. A transceiver as claimed in claim 4 wherein said feedback control circuit comprises a delay controller configured to maintain temporal alignment between said processed-cancellation signal and said RF receive signal at said combiner.

6. A transceiver as claimed in claim 4 wherein said feedback control circuit is configured to generate said processed-cancellation signal in response to correlation between said leakage-compensated receive signal and said raw-cancellation signal.

7. A transceiver as claimed in claim 6 wherein:
said feedback control circuit is configured to downconvert said raw-cancellation signal to generate a downconverted-raw-cancellation signal;
said RF receiver is configured to downconvert said leakage-compensated receive signal to generate a downconverted-leakage-compensated-receive signal; and
said feedback-control circuit is configured to generate said processed-cancellation signal in response to correlation between said downconverted-leakage-compensated-receive signal and said downconverted-raw-cancellation signal.

8. A transceiver as claimed in claim 7 wherein:
said second isolation filter is configured to exhibit a passband having a predetermined bandwidth;
said RF receiver is configured to filter said downconverted-leakage-compensated-receive signal through a filter having a passband more narrow than said predetermined bandwidth to produce a reduced-bandwidth-downconverted-leakage-compensated-receive signal; and
said feedback control circuit is configured to-generate said processed-cancellation signal in response to correlation between said reduced-bandwidth-downconverted-leakage-compensated-receive signal and said downconverted-raw-cancellation signal.

9. A transceiver as claimed in claim 7 wherein said downconverted-raw-cancellation signal is a digital signal stream and said downconverted-leakage-compensated-receive signal is a digital signal stream.

10. A transceiver as claimed in claim 9 wherein:
said RF receiver comprises a first analog-to-digital converter configured to generate said downconverted-leakage-compensated-receive signal stream at a first data rate;
said feedback control circuit comprises a second analog-to-digital converter configured to generate said downconverted-raw-cancellation signal stream at a second data rate, said second data rate being faster than said first data rate; and
said feedback control circuit additionally comprises a rate converter configured to adjust the data rate of one of said downconverted-leakage-compensated-receive signal stream and said downconverted-raw-cancellation signal stream to substantially match the other of said downconverted-leakage-compensated-receive signal stream and said downconverted-raw-cancellation signal stream.

11. A transceiver as claimed in claim 7 wherein said feedback control circuit includes a subharmonic-sampling downconverter configured to digitize and downconvert said raw-cancellation signal.

12. A transceiver as claimed in claim 3 wherein:
said RF receive signal has a spectral content primarily concentrated in a receive-frequency band and said RF transmit signal has a spectral content primarily concentrated in a transmit-frequency band;
said feedback control circuit comprises a filter adapted to receive and filter said raw-cancellation signal, said filter being configured to pass said receive-frequency band and to attenuate said transmit-frequency band.

13. A transceiver as claimed in claim 12 wherein said filter of said feedback control circuit is configured to exhibit spectral characteristics approximately equal to spectral characteristics of said second isolation filter.

14. A transceiver as claimed in claim 3 wherein said control circuit is configured to equalize said raw-cancellation signal to generate said processed-cancellation signal.

15. A transceiver as claimed in claim 1 wherein:
said transceiver additionally comprises a directional coupler having an input port coupled to said output of said first isolation filter, having an output port, and having a coupled port; and
said control input of said feedback control circuit is adapted to obtain said RF transmit signal from said coupled port of said directional coupler.

16. A transceiver as claimed in claim 1 wherein said output of said first isolation filter couples to said input of said second isolation filter.

17. A transceiver as claimed in claim 1 wherein said first and second isolation filters are provided by a duplexer.

18. A transceiver as claimed in claim 1 wherein said RF transmitter is configured to generate said RF transmit signal at an average power level of greater than 1 watt.

20. A transceiver with isolation-filter compensation, said transceiver comprising:
an RF transmitter configured to generate an RF transmit signal;
a first isolation filter having an input adapted to receive said RF transmit signal and to distort said RF transmit signal while passing said RF transmit signal to an output of said first isolation filter;
an RF receiver configured to process an RF receive signal;
a second isolation filter having an input adapted pass said RF receive signal from said input of said second isolation filter to an output of said second isolation filter, said output of said second isolation filter being coupled to said RF receiver; and
a feedback control circuit coupled to said RF transmitter, said feedback control circuit having a control input adapted to obtain said RF transmit signal from said output of said first isolation filter, and said feedback control circuit being configured to control predistortion applied in said RF transmitter to compensate for distortion imparted to said RF transmit signal by said first isolation filter in response to said RF transmit signal obtained from said output of said first isolation filter.

21. A transceiver as claimed in claim 20 wherein:
said feedback control circuit is a first feedback control circuit;
said input of second isolation filter is adapted to receive said RF transmit signal and to leak a portion of said RF transmit signal at said output of said second isolation filter; and
said transceiver additionally comprises a second feedback control circuit coupled to said RF receiver and to said first isolation filter, said second feedback control circuit being configured to compensate said RF receiver for said leaked portion of said RF transmit signal at said output of said second isolation filter.

22. A transceiver as claimed in claim 20 wherein said output of said first isolation filter couples to said input of said second isolation filter.

23. A transceiver as claimed in claim 20 wherein said first and second isolation filters are provided by a duplexer.

24. A transceiver as claimed in claim 20 wherein said feedback control circuit comprises a digital-subharmonic-sampling downconverter having an input coupled to said output of said first isolation filter.

25. A transceiver as claimed in claim 20 wherein said RF transmitter comprises a linear predistorter coupled to said feedback control circuit, said linear predistorter being configured to predistort a forward-data stream that digitally conveys information to compensate for distortion introduced downstream of said linear predistorter by said first isolation filter.

26. A transceiver as claimed-in claim 25 wherein:
said linear predistorter additionally predistorts said forward-data stream to compensate for linear distortion introduced downstream of said linear predistorter by analog-transmitter components; and
said RF transmitter additionally comprises a nonlinear predistorter coupled to said feedback control circuit, said nonlinear predistorter being configured to predistort said forward-data stream to compensate for nonlinear distortion introduced downstream of said nonlinear predistorter by said analog-transmitter components.

27. A transceiver as claimed in claim 25 wherein said linear predistorter comprises an equalizer which operates in an adaptive mode to compensate for said distortion.

28. A transceiver as claimed in claim 25 wherein:
said feedback section comprises an analog-to-digital converter configured to digitize said RF transmit signal into a return-data stream;
said feedback control circuit additionally comprises a delay element configured to delay said forward-data stream into a delayed-forward-data stream in temporal alignment with said return-data stream;
said feedback control circuit additionally comprises a combiner configured to form an error signal from said delayed-forward-data stream and said return-data stream; and
said linear-predistorter is configured to be trained to compensate for said linear distortion introduced by said first isolation filter by implementing an estimation-and-convergence algorithm that converges upon filter coefficients which minimize said distortion.

29. A transceiver as claimed in claim 20 wherein said RF transmitter is configured to generate said RF transmit signal at an average power level of greater than 1 watt.

30. A method of operating an RF communications transceiver to compensate for leakage of an RF transmit signal into an RF receive signal, said method comprising:
generating said RF transmit signal;
extracting a portion of said RF transmit signal to form a raw-cancellation signal;
applying a transformation function to-said raw-cancellation signal to-generate a processed-cancellation signal;
combining said processed-cancellation signal with said RF receive signal to form a leakage-compensated receive signal; and
adjusting said transformation function in response to said leakage-compensated receive signal.

31. A method as claimed in claim 30 additionally comprising implementing a feedback loop to maintain temporal alignment between said processed-cancellation signal and said RF receive signal during said combining activity.

32. A method as claimed in claim 30 wherein said applying activity is performed in an equalizer.

33. A method as claimed in claim 30 wherein said adjusting activity adjusts said transformation function in response to correlation between said leakage-compensated receive signal and said raw-cancellation signal.

34. A method as claimed in claim 32 wherein:
said transformation function is defined by coefficients supplied to said equalizer; and
said adjusting activity adjusts said coefficients in response to said leakage-compensated receive signal.

35. A method as claimed in claim 30 additionally comprising passing said RF transmit signal through a duplexer that causes a portion of said RF transmit signal to leak into said RF receive signal.

36. A method as claimed in claim 35 wherein:
said RF receive signal has a spectral content primarily concentrated in a receive-frequency band and said RF transmit signal has a spectral content primarily concentrated in a transmit-frequency band;
said duplexer includes an isolation filter that is configured to pass said receive-frequency band and to attenuate said transmit-frequency band;
said method additionally comprises passing said RF receive signal through said isolation filter prior to said combining activity; and
said method additionally comprises, prior to said transformation-function applying activity, filtering said raw-cancellation signal so as to pass said receive-frequency band and to attenuate said transmit-frequency band.

37. A method as claimed-in claim 35 wherein:
said duplexer distorts said RF transmit signal as said RF transmit signal passes through said duplexer;
said extracting activity extracts said portion of said RF transmit signal after said RF transmit signal has passed through said duplexer;
said RF transmit signal is generated in an upconverter located upstream of said duplexer, said upconverter being configured to upconvert a forward-communication signal;
said method additionally comprises applying a predistortion transformation function to said forward-communication signal upstream of said upconverter; and
said method additionally comprises adjusting said predistortion transformation function in response to said portion of said RF transmit signal extracted in said extracting activity to compensate for distortion imparted to said RF transmit signal in said duplexer.

38. A method as claimed in claim 30 wherein:
said method additionally comprises downconverting said raw-cancellation signal to generate a downconverted-raw-cancellation signal;
said method additionally comprises downconverting said leakage-compensated receive signal to generate a downconverted-leakage-compensated-receive signal; and
said adjusting activity adjusts said transformation function in response to correlation between said downconverted-leakage-compensated receive signal and said downconverted-raw-cancellation signal.

39. A method as claimed in claim 38 wherein said raw-cancellation-signal-downconverting activity downconverts said raw-cancellation signal using a subharmonic-sampling downconverter.
